(19) United States
(12) Patent Application Publication
(10) Pub. No.: US 2004/0255704 A1
(43) Pub. Date: Dec. 23, 2004

(54) Planetary gearset reduction ring gear for motor vehicle starter

(76) Inventor: Zeng Gang Liu, Maurecourt (FR)

Correspondence Address: Longacre & White, Suite 240, 6550 Rock Spring Drive, Bethesda, MD, 20817, US

(21) Appl. No.: 10/487,909

(22) PCT Filed: Sep. 16, 2002
(86) PCT No.: PCT/FR02/03138

(30) Foreign Application Priority Data
Sep. 14, 2001 (FR) 01/11927

(51) Int. Cl. F02N 1/00

(52) U.S. Cl. 74/7 E

(57) ABSTRACT

The invention concerns a reduction gear ring of the epicyclic train type, in particular for motor vehicle starters, mounted so as to be immovable with respect to rotation in a casing and comprising internal teeth which mesh with the planet wheels of the gear box.

This ring, characterised in that it is composed of two parts, an external part (31) mounted in the said casing and an internal ring part (33) carrying the internal tooth, which is able to be mounted coaxially in the external ring part (31) and is formed by several separate ring segments (35, 36).

The invention can be used for motor vehicles.

The invention concerns a reduction gear ring of the epicyclic train type, in particular for a motor vehicle starter, mounted immovably with respect to rotation in a casing and comprising internal teeth which mesh with the planet wheels of the reduction gear, and a starter comprising such a reduction gear ring.

### PRIOR ART

It is known how to use, in starters for motor vehicles, steel rings in cases of application involving very severe stresses. However, a sintered steel ring has the major drawback, added to its very expensive cost, that is has a certain degree of fragility. It has then been envisaged using rings made from forged steel. These rings have proved satisfactory with regard to the mechanical properties, but their use comes up against much too high a cost, that is to say more than two and a half times that of a ring made from sintered steel.

### OBJECT OF THE INVENTION

The object of the invention is to mitigate this drawback and to propose a ring with reduced manufacturing cost and tooling.

To achieve this aim, a reduction gear ring according to the invention is characterised in that it is used in the form of a multipart ring, each part being able to be manufactured separately.

According to one characteristic of the invention, the ring is composed of two parts, an external part mounted in the casing of the machine which it equips and an internal ring part carrying the internal teeth and which is able to be mounted coaxially in the external ring part and is formed by several separate ring segments.

According to another characteristic of the invention, each ring segment comprises, on its external peripheral surface, stop ribs intended to wedge in complementary recesses provided on the external ring part.

According to another characteristic of the invention, each ring segment stop rib is received in a damper forming part of the external ring part.

According to yet another characteristic of the invention, a ring segment stop rib is received between two blocks made from damping material, wedged between two stops on the external ring part.

According to yet another characteristic of the invention, the internal ring is advantageously produced in two or four segments.

The starter according to the invention is characterised in that it comprises a reduction gear ring comprising the above-mentioned characteristics.

### SUMMARY DESCRIPTION OF THE DRAWINGS

The invention will be better understood, and other aims, characteristics, details and advantages thereof will emerge more clearly in the following explanatory description made with reference to the accompanying schematic drawings, given solely by way of example illustrating one embodiment of the invention and in which:

FIG. 1 is a view in partial axial section of a starter of the epicyclic gear train type according to the prior art,

FIGS. 2 and 3 are perspective views of two versions of an embodiment of a reduction gear ring according to the invention.

### DESCRIPTION OF PREFERENTIAL EMBODIMENTS OF THE INVENTION

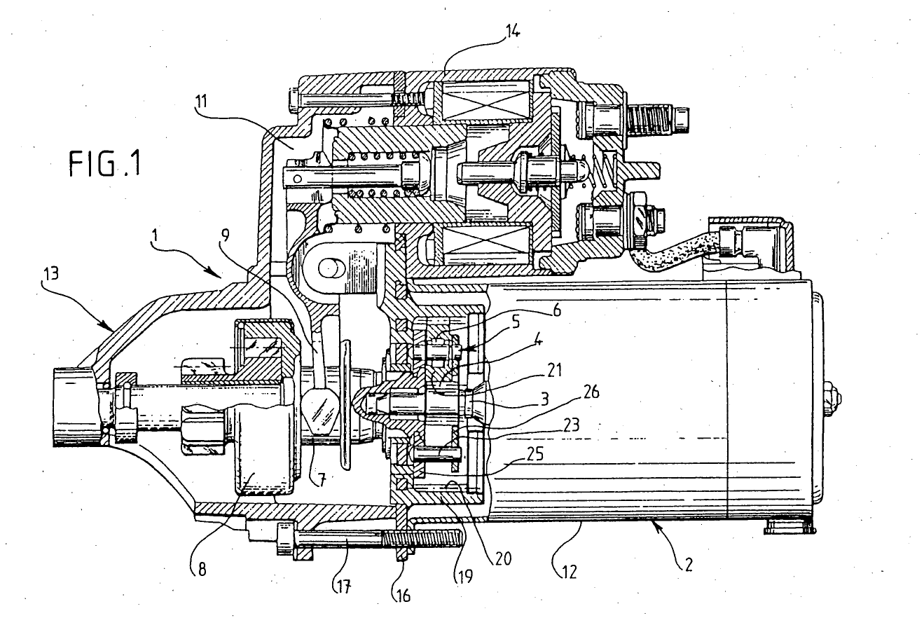

Referring to FIG. 1, a description is first of all given of a motor vehicle starter 1 of the epicyclic gear train type, from the prior art, in order to demonstrate the general structure of a starter in which the reduction gear ring device according to the invention is incorporated.

According to FIG. 1, a known starter 1 comprises an electric motor 2 comprising an armature which drives a shaft 3 carrying, at its free end, a pinion 4. A reduction gear 5 with epicyclic train 6 is interposed between the pinion 4 and a starter head shaft 7 coaxial with the output shaft 3 of the electric motor 2, the starter head 8 being able to be moved on the shaft 7 by means of a lever 9 in the form of the fork of an electromagnetic contactor 11 disposed in the top part of the starter. The electric motor 2 and the reduction gear are enclosed in a carcass 12 to which there is fixed a front part in the form of a cap 13 on which the casing 14 of the contactor 11 is also mounted.

The reduction gear 5 comprises a base plate 16 fixed to the carcass 12 and the casing 14, by screws 17 for fixing the cap 13 to the carcass 12 and the casing 14, and a ring 19 cast on the plate 16 in the starter depicted.

The ring 19 comprises internal teeth 20 which mesh with the planet wheels 21 of the epicyclic train 6. The planets are mounted on shafts 23 carried by a planet-holder plate 25 rotationally fixed to the starter head shaft 7 and immobilised axially in translation by a plate 26 force-fitted on the planet shafts 23.

The invention concerns specifically the design of the reduction gear ring of a starter of the type depicted in FIG. 1.

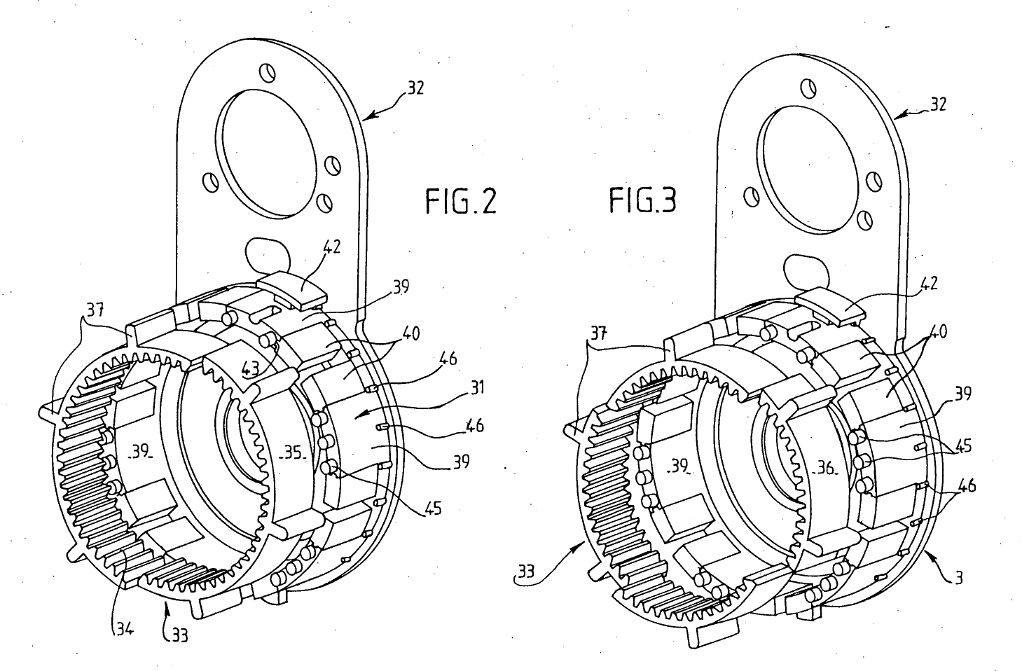

As shown by FIGS. 2 and 3, a ring according to the invention comprises a first part designated by the reference 31 which is intended to be mounted fixed in the starter and is composed of a cylindrical part forming a housing 31 fixed to a plate 32 corresponding to the plate 16 of the known starter depicted in FIG. 1 and an internal ring part 33 which carries the internal teeth 34 and is able to be coaxially mounted in the housing 31.

As shown by FIGS. 2 and 3, the internal ring 33 is composed, in the version of the embodiment in FIG. 2, of two semi-cylindrical annular segments 35 and, in the version in FIG. 3, four annular segments 36 each in the form of an arc of a circle of 900, each segment advantageously being produced from forged iron.

Each ring segment 35 in FIG. 2 comprises, on its external peripheral face, three stop ribs 37 which project radially towards the outside and are intended to provide the mounting and fixing, coaxially, in the ring housing 31.

The latter has, for this purpose, a number of segments 39, each in the form of an arc of a circle, projecting axially from the base plate 32, which is equal to the total number of stop ribs 37. The housing segments 39 are distributed angularly equidistant and sized so as to allow the interposing between two segments 39 of two damper blocks 40 made from any appropriate material such as rubber, which are disposed so as to leave between them a separation distance in which a segment stop rib 37 of the internal ring 32 is inserted. The segments 39 are advantageously made from plastics material and moulded or clipped onto the base plate 32. The damper blocks 40 are moulded onto the support 39 or fixed with these by a device with rib and groove as can be seen at 43 in FIGS. 2 and 3. At 42 a cylinder head locating element is indicated.

The version of an embodiment of the ring according to the invention depicted in FIG. 3 is distinguished from the version in FIG. 2 solely by the fact that there are four segments and each internal ring segment 36 comprises at least one stop rib of the same type as the rib 37 in FIG. 2.

It should also be noted that studs 46 project axially from the free front face of the segments 39 in order to obtain an expansion space for the damper blocks 40. A dust plate, not shown, comes into abutment against the segments 39 in order to prevent dust from entering the gear box and grains from coming out of the latter. The figures also indicate at 46 centring studs for the cylinder head, in particular in its monobloc version with segments 39.

The multipart ring according to the invention, as depicted in FIGS. 2 and 3, balances the force of the gear planets in the case of shocks and in the case of normal driving. The damper blocks reduce both torsional and radial shocks. The multipart ring according to the invention is applicable to all starters with gears where a ring made from plastics material does not satisfy the load constraints with regard to wear and the risk of breakage of the teeth and where the single-part steel rings are too expensive in terms of production cost and tooling.

1. Reduction gear ring of the epicyclic train type, in particular for motor vehicle starters, mounted so as to be movable with respect to rotation in a casing and comprising internal teeth which mesh with the planet wheels of the gearing, characterised in that it is composed of two parts, an external part (31) mounted in the said casing and an internal ring part (33) carrying the internal teeth, which is able to be mounted coaxially in the external ring part (31) and is formed by several separate ring segments (35, 36).

2. Reduction gear ring according to claim 1, characterised in that each ring segment (35, 36) comprises on its external peripheral face at least one stop rib (37) intended to be wedged in complementary recesses provided on the external ring part (31).

3. Reduction gear ring according to claim 2, characterised in that each ring segment stop rib (37) is received in a damper (40) forming part of the external ring part (31).

4. Reduction gear ring according to claim 3, characterised in that a ring segment stop rib (37) is received between two blocks (40) made from a damping material, wedged between two stops (39) on the external ring part (31).

5. Reduction gear ring according to claim 1, characterised in that the internal ring (32) is produced in two (35) or four segments (36) with an equal angular extent.

6. Reduction gear ring according to claim 1, characterised in that each ring segment (35, 36) is produced from forged steel.

7. Reduction gear ring according to claim 4, characterised in that each stop comprises studs (45) projecting axially on its free front surface, intended to establish an expansion space for the damper blocks (40).

8. Motor vehicle starter of the type with an epicyclic gear train comprising a ring with internal teeth mounted so as to be immovable with respect to rotation in the carcass of the gear box, characterised by a reduction gear ring according to claim 1.
